(19) United States
(12) Patent Application Publication
(10) Pub. No.: US 2025/0274055 A1
(43) Pub. Date: Aug. 28, 2025

(54) OUTPUT CONTROL CIRCUIT, AND SWITCHING POWER SUPPLY

(71) Applicant: Zhuhai Nanxin Semiconductor Technology Co., Ltd., Zhuhai City (CN)

(72) Inventors: Jianlong Gao, Zhuhai City (CN); Lin Feng, Zhuhai City (CN); Kun Yang, Zhuhai City (CN)

(21) Appl. No.: 19/065,684

(22) Filed: Feb. 27, 2025

(30) Foreign Application Priority Data
Feb. 27, 2024 (CN) 202410214931.5

(51) Int. Cl. H02M 7/219; H02M 1/00; H02M 7/04

(52) U.S. Cl. CPC H02M 7/219; H02M 1/009; H02M 7/05

(57) ABSTRACT

An output control circuit includes a power transformer, a secondary power loop, and a secondary control circuit. The secondary control circuit acquires the electrical signal on the at least one load, and transmits the control signal to the secondary power loop based on the electrical signal used for representing the energy required by the at least one load. The secondary power loop converts the energy stored in the power transformer into at least one power output based on the control signal, and transmits the at least one power output to the at least one load, such that the at least one load operates. Since one power transformer is configured, and the secondary power loop includes no inductor, the numbers of power transformers and inductors in the output control circuit are reduced. Therefore, the size of the output control circuit and the size of the switching power supply are reduced.

### CROSS-REFERENCE TO RELATED APPLICATION

This application is based upon and claims the priority of Chinese Patent Application No. 202410214931.5, filed on Feb. 27, 2024, the entire contents of which are hereby incorporated by reference.

### TECHNICAL FIELD

The present disclosure relates to the technical field of switching power supplies, and in particular, relates to an output control circuit, an output control method, a switching power supply, a chip, and an electronic device.

### BACKGROUND

With the development of fast charging technologies, high-power, compact, and multi-output switching power supplies are being more and more widely used in adapters. At present, the multi-output switching power supplies are mainly implemented using two solutions:

In a first solution, a single flyback converter (Flyback) converts alternating current (AC) mains into direct current (DC) voltages, and multiple buck converters (Buck) further step down the DC voltage to achieve multi-output functionality.

In a second solution, multiple flyback converters are connected in parallel to form a multi-output flyback system, thereby meeting the multi-output requirements.

However, both of these two solutions require multiple inductors or power transformers for energy conversion, and thus the switching power supply has a large size.

### SUMMARY

Accordingly, some embodiments of the present disclosure provide an output control circuit, an output control method, a switching power supply, a chip, and an electronic device. With these solutions, the numbers of power transformers and inductors are decreased, and the size of the switching power supply is reduced.

In a first aspect, the embodiments of the present disclosure provide an output control circuit, configured to control a magnitude of power provided to at least one load. The output control circuit includes a power transformer, a secondary power loop, and a secondary control circuit, wherein one power transformer is configured, and the secondary power loop includes no inductor.

A first terminal of the secondary control circuit is electrically connected to at least one load, a second terminal of the secondary control circuit is electrically connected to a first control terminal of the secondary power loop, and a third terminal of the secondary control circuit is electrically connected to a second control terminal of the secondary power loop.

A first terminal of the secondary power loop is electrically connected to a first terminal of a secondary winding of the power transformer, a second terminal of the secondary power loop is electrically connected to a second terminal of the secondary winding of the power transformer, and the at least one load is connected in series in the secondary power loop.

The secondary control circuit is configured to acquire an electrical signal on the at least one load, and transmit a control signal to the secondary power loop based on the electrical signal, wherein the electrical signal is used for representing energy required by the at least one load.

The secondary power loop is configured to, based on the control signal, convert energy stored in the power transformer into at least one power output, and transmit one of the at least one power output to each of the at least one load.

In the output control circuit according to the first aspect, the secondary control circuit acquires the electrical signal on the at least one load, and the secondary control circuit may transmit the control signal to the secondary power loop based on the electrical signal used for representing the energy required by the at least one load. In this way, the secondary power loop may convert the energy stored in the power transformer into at least one power output based on the control signal. Furthermore, the secondary power loop may transmit the at least one power output to the at least one load, such that the at least one load may operate. Since one power transformer is configured, and the secondary power loop includes no inductor, the numbers of power transformers and inductors in the output control circuit are reduced. In this way, the size of the output control circuit and the size of the switching power supply are reduced.

In some embodiments, in a case where the at least one load includes a first load and a second load, with respect to each cycle where the power transformer is in an energy release state, the secondary power loop is configured to, based on the control signal, divide the energy stored in the power transformer into a first power output and a second power output, transmit the first power output to the first load, and transmit the second power output to the second load.

Alternatively, with respect to two adjacent cycles where the power transformer is in an energy release state, the secondary power loop is configured to, based on the control signal, convert the energy stored in the power transformer into a first power output and transmit the first power output to the first load within a previous cycle of the two adjacent cycles, and convert the energy stored in the power transformer into a second power output and transmit the second power output to the second load within a subsequent cycle of the two adjacent cycles.

In a case where the at least one load includes one load, with respect to each cycle where the power transformer is in an energy release state, the secondary power loop is configured to, based on the control signal, convert the energy stored in the power transformer into one power output and transmit the one power output to the one load.

In some embodiments, the output control circuit further includes a power supply absorption circuit.

An input terminal of the power supply absorption circuit is electrically connected to the first terminal of the secondary winding of the power transformer or a third terminal of the secondary power loop, and an output terminal of the power supply absorption circuit is electrically connected to a power terminal of the secondary control circuit.

The power supply absorption circuit is configured to provide an operating voltage to the secondary control circuit to start the secondary control circuit.

In some embodiments, the power supply absorption circuit is further configured to absorb a spike voltage generated by the secondary power loop in a case where the secondary power loop converts the energy stored in the power transformer into at least one power output.

In some embodiments, the power supply absorption circuit includes a diode and a first capacitor.

A first terminal of the diode is electrically connected to the first terminal of the secondary windings of the power transformer or the third terminal of the secondary power loop, a second terminal of the diode is electrically connected to a first terminal of the first capacitor, a second terminal of the first capacitor is grounded, and the power terminal of the secondary control circuit is electrically connected between the second terminal of the diode and the first terminal of the first capacitor.

In some embodiments, in a case where the operating voltage of the secondary control circuit is equal to or greater than a predetermined voltage, the secondary winding of the power transformer includes a central tap.

The central tap is configured to divide coils of the seconding winding of the power transformer into a first coil group and a second coil group, wherein a first terminal of the first coil group is electrically connected to the input terminal of the power supply absorption circuit, a second terminal of the first coil group is electrically connected to a first terminal of the second coil group, the central tap is positioned between the second terminal of the first coil group and the first terminal of the second coil group, the central tap is electrically connected to the first terminal of the secondary power loop, and a second terminal of the second coil group is electrically connected to the second terminal of the secondary power loop.

In some embodiments, the control signal includes a first control signal and a second control signal; and the secondary power loop includes a synchronous rectifier circuit and a power distribution circuit.

A control terminal of the synchronous rectifier circuit is electrically connected to the second terminal of the secondary control circuit, and a control terminal of the power distribution circuit is electrically connected to the third terminal of the secondary control circuit.

The first terminal of the secondary winding of the power transformer is electrically connected to a first terminal of the synchronous rectifier circuit, a second terminal of the synchronous rectifier circuit is electrically connected to an input terminal of the power distribution circuit, and an output terminal of the power distribution circuit is electrically connected to the second terminal of the secondary winding of the power transformer via the at least one load.

Alternatively, the first terminal of the secondary winding of the power transformer is electrically connected to an input terminal of the power distribution circuit, an output terminal of the power distribution circuit is electrically connected to a second terminal of the synchronous rectifier circuit via the at least one load, and a first terminal of the synchronous rectifier circuit is electrically connected to the second terminal of the secondary winding of the power transformer.

The synchronous rectifier circuit is configured to, based on the first control signal, rectify the energy stored in the power transformer, and transmit rectified energy to the power distribution circuit.

The power distribution circuit is configured to, based on the second control signal, convert the rectified energy into at least one power output, and transmit the at least one power output to the at least one load.

In some embodiments, the second control signal includes at least one first sub-control signal and at least one second sub-control signal; and the power distribution circuit includes at least two distribution assemblies and at least two switching transistors, the distribution assemblies being in one-to-one correspondence with the switching transistors.

A control terminal of each of the distribution assemblies and a control terminal of each of the switching transistors are both electrically connected to the third terminal of the secondary control circuit, a first terminal of the each of the distribution assemblies is electrically connected to the second terminal of the synchronous rectifier circuit or the first terminal of the secondary winding of the power transformer, a second terminal of the each of the distribution assemblies is electrically connected to a first terminal of the each of the switching transistors, and a second terminal of the each of switching transistors is electrically connected to the at least one load.

The at least two distribution assemblies are configured to be turned on based on the at least one first sub-control signal to convert the rectified energy into at least one power output respectively.

The at least two switching transistors are configured to enable electrical connection between the at least two distribution assemblies and the at least one load based on the at least one second sub-control signal to transmit the at least one power output to the at least one load respectively.

In some embodiments, the at least two distribution assemblies include a first distribution assembly and a second distribution assembly, the at least two switching transistors include a first switching transistor and a second switching transistor, the at least one first sub-control signal includes a first sub-control signal and another first sub-control signal, and the at least one second sub-control signal includes a second sub-control signal and another second sub-control signal.

A control terminal of the first distribution assembly, a control terminal of the second distribution assembly, a first terminal of the first switching transistor and a control terminal of the second switching transistor are all electrically connected to the third terminal of the secondary control circuit, a first terminal of the first distribution assembly and a first terminal of the second distribution assembly are both electrically connected to the second terminal of the synchronous rectifier circuit or the first terminal of the secondary winding of the power transformer, a second terminal of the first distribution assembly is electrically connected to the first terminal of the first switching transistor, and a second terminal of the second distribution assembly is electrically connected to a first terminal of the second switching transistor.

In a case where the at least one load includes a first load and a second load, with respect to each cycle where the power transformer is in an energy release state, the first distribution assembly is configured to be turned on in a first time period within the each cycle based on the first sub-control signal, to acquire the first power output.

The first switching transistor is configured to enable electrical connection between the first distribution assembly and the first load in the first time period within the each cycle based on the second sub-control signal, to transmit the first power output to the first load.

The second distribution assembly is configured to be turned on in a second time period within the each cycle based on the another first sub-control signal, to acquire the second power output.

The second switching transistor is configured to enable electrical connection between the second distribution assembly and the second load in a second time period within the each cycle based on the another second sub-control signal, to transmit the second power output to the second load.

Alternatively, with respect to two adjacent cycles where the power transformer is in an energy release state, the first distribution assembly is configured to be turned on within a previous cycle of the two adjacent cycles based on the first sub-control signal, to acquire the first power output.

The first switching transistor is configured to enable electrical connection between the first distribution assembly and the first load within the previous cycle of the two adjacent cycles based on the second sub-control signal, to transmit the first power output to the first load.

The second distribution assembly is configured to be turned on within a subsequent cycle of the two adjacent cycles based on the another first sub-control signal, to acquire the second power output.

The second switching transistor is configured to enable electrical connection between the second distribution assembly and the second load within the subsequent cycle of the two adjacent cycles based on the another second sub-control signal, to transmit the second power output to the second load.

In a case where the at least one load includes one load, with respect to each cycle where the power transformer is in an energy release state, the first distribution assembly is configured to be turned on within the each cycle based on the first sub-control signal, to acquire a portion of power in the one power output.

The second distribution assembly is configured to be turned on within the each cycle based on the another first sub-control signal, to acquire another portion of power in the one power output.

The first switching transistor is configured to be turned on within the each cycle based on the second sub-control signal, and enable electrical connection between the first distribution assembly and the one load, to transmit the one power output to the one load; or the second switching transistor is configured to be turned on within the each cycle based on the another second sub-control signal, and enable electrical connection between the second distribution assembly and the one load, to transmit the one power output to the one load.

In some embodiments, the distribution assembly includes a first power transistor and an output capacitor.

A control terminal of the first power transistor is electrically connected to the second terminal of the secondary control circuit, a first terminal of the first power transistor is electrically connected to the second terminal of the synchronous rectifier circuit or the first terminal of the secondary winding of the power transformer, a second terminal of the first power transistor is electrically connected to a first terminal of the output capacitor, a second terminal of the output capacitor is grounded, the first terminal of the first switching transistor or the first terminal of the second switching transistor is electrically connected between the second terminal of the first power transistor and the first terminal of the output capacitor.

In some embodiments, a capacitance value of the output capacitor is less than a predetermined capacitance value.

In some embodiments, the distribution assembly further includes a second power transistor.

A control terminal of the second power transistor is electrically connected to the second terminal of the secondary control circuit, a second terminal of the second power transistor is electrically connected to the first terminal of the first power transistor, and a first terminal of the second power transistor is electrically connected to the first terminal of the output capacitor.

In a second aspect, the embodiments of the present disclosure provide an output control method, applicable to the output control circuit according to the first aspect and various embodiments thereof.

The method includes: acquiring, by the secondary control circuit, an electrical signal on the at least one load, and transmitting a control signal to the secondary power loop based on the electrical signal, wherein the electrical signal is used for representing energy required by the at least one load; and converting, based on the control signal by the secondary power loop, energy stored in the power transformer into at least one power output, and transmitting the at least one power output to the at least one load.

In a third aspect, the embodiments of the present disclosure provide a switching power supply. The switching power supply includes a primary power loop and the output control circuit according to the first aspect and various embodiments thereof.

In a fourth aspect, the embodiments of the present disclosure provide a chip. The chip includes the output control circuit according to the first aspect and various embodiments thereof, or the switching power supply according to the third aspect.

In a fifth aspect, the embodiments of the present disclosure provide an electronic device. The electronic device includes the chip according to the fourth aspect.

### BRIEF DESCRIPTION OF THE DRAWINGS

FIG. 1 is a schematic structural diagram of a switching power supply in a first solution of the related art;

FIG. 2 is a schematic structural diagram of a switching power supply in a second solution of the related art;

FIG. 3 is a schematic structural diagram of a switching power supply according to some embodiments of the present disclosure;

FIG. 4 is a schematic structural diagram of an output control circuit according to some embodiments of the present disclosure;

FIG. 5 is a schematic flowchart of an output control method according to some embodiments of the present disclosure;

FIG. 6 is a schematic structural diagram of an output control circuit according to some embodiments of the present disclosure;

FIG. 7 is a schematic structural diagram of an output control circuit according to some embodiments of the present disclosure;

FIG. 8 is a schematic structural diagram of an output control circuit according to some embodiments of the present disclosure;

FIG. 9 is a schematic structural diagram of an output control circuit according to some embodiments of the present disclosure;

FIG. 10 is a schematic structural diagram of an output control circuit according to some embodiments of the present disclosure;

FIG. 11 is a schematic structural diagram of an output control circuit according to some embodiments of the present disclosure;

FIG. 12 is a schematic diagram of an operating waveform of an output control circuit according to some embodiments of the present disclosure;

FIG. 13 is a schematic diagram of an operating waveform of an output control circuit according to some embodiments of the present disclosure;

FIG. 14 is a schematic diagram of an operating waveform of an output control circuit according to some embodiments of the present disclosure; and

FIG. 15 is a schematic diagram of an operating waveform of an output control circuit according to some embodiments of the present disclosure.

### DETAILED DESCRIPTION

In the present disclosure, the term “at least one” refers to one or more than one, and the term “a plurality of” refers to two or more than two. The term “and/or” is merely an association relationship for describing associated objects, which represents that there may exist three types of relationships, for example, A and/or B may represent three situations: only A exists, both A and B exist, and only B exists, wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

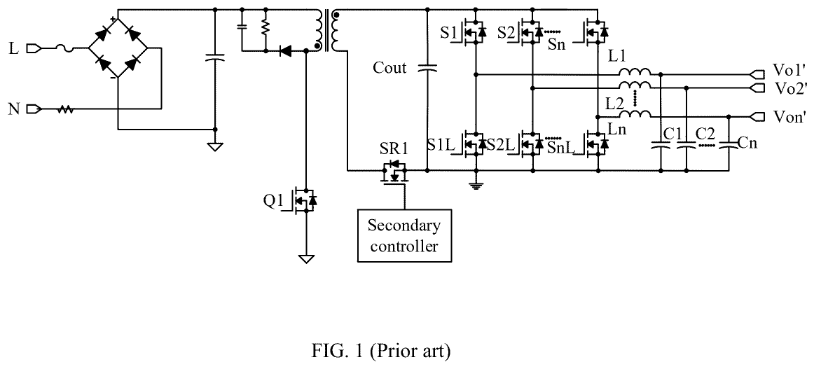

FIG. 1 is a schematic structural diagram of a switching power supply in a first solution of the related art. As illustrated in FIG. 1, for example, in an application scenario of a 65 W dual output adapter, a flyback converter converts AC mains (i.e., an alternating current output from a live wire L and a neutral wire N) into a DC voltage, with the DC voltage serving as a bus voltage VBUS. For example, the bus voltage VBUS is typically around 21 V. The flyback converter includes a power transistor Q1, a power transformer, a rectifier SR1, a secondary controller, and an output capacitor Cout. The bus voltage VBUS is then converted into output voltages (i.e., vo1′, vo2′, and von′) required by the loads via two buck converters. The buck converter includes a power transistor S1, a power transistor S1L, a power transistor S2, a power transistor S2L, a power transistor Sn, a power transistor SnL, an inductor L1, an inductor L2, an inductor Ln, a capacitor C1, a capacitor C2, and a capacitor Cn

In the first solution, since each buck converter requires a separate inductor and capacitor, the size of the switching power supply is large. Furthermore, the presence of two-stage conversion from the AC mains to the output voltages required by the loads leads to poor efficiency and electromagnetic compatibility (EMC) of the switching power supply.

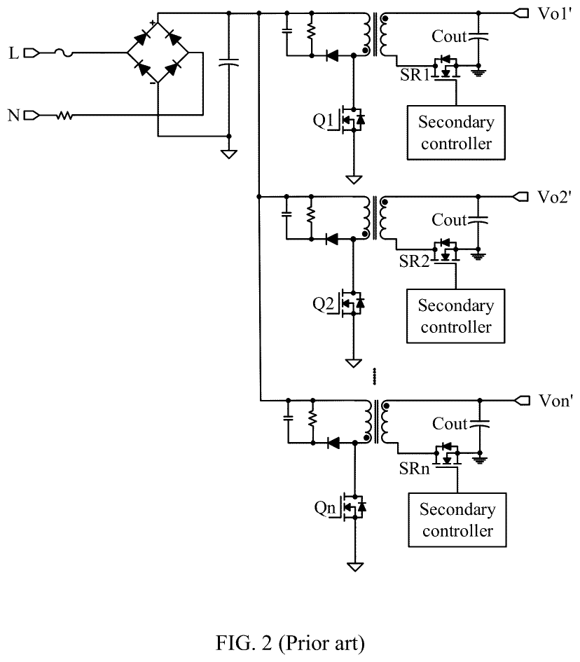

FIG. 2 is a schematic structural diagram of a switching power supply in a second solution of the related art. As illustrated in FIG. 2, multiple outputs of the switching power supply are achieved by receiving the AC voltages output from the live wire L and the neutral wire N by multiple flyback converters.

The multiple outputs of the switching power supply may include a first output vo1′, a second output vo2′, and an n^{th} output von′. The multiple flyback converters may include a first flyback converter, a second flyback converter, and an n^{th} flyback converter.

The first flyback converter may include a power transistor Q1, a power transformer, a rectifier SR1, and a capacitor Cout. A secondary winding of a power transformer is electrically connected to both the capacitor Cout and the rectifier SR1.

The second flyback converter may include a power transistor Q2, a power transformer, a rectifier SR2, and a capacitor Cout. The secondary winding of the power transformer is electrically connected to both the capacitor Cout and the rectifier SR2.

The n^{th} flyback converter may include a power transistor Qn, a power transformer, a rectifier SRn, and a capacitor Cout. The secondary winding of the power transformer is electrically connected to both the capacitor Cout and the rectifier SRn.

In the second solution, since each flyback converter requires a separate power transformer and capacitor, the size of the switching power supply is relatively large. Moreover, current sharing and voltage regulation control policies for each flyback converter are more complex.

Based on the above description, in both the first solution and the second solution, the switching power supply has a relatively large size.

Accordingly, some embodiments of the present disclosure provide an output control circuit, an output control method, a switching power supply, a chip, and an electronic device.

The switching power supply and the output control circuit may be both chips or circuit modules.

In the present disclosure, the electronic device may include, but is not limited to, a television, a tablet computer, an adapter, and an audio device.

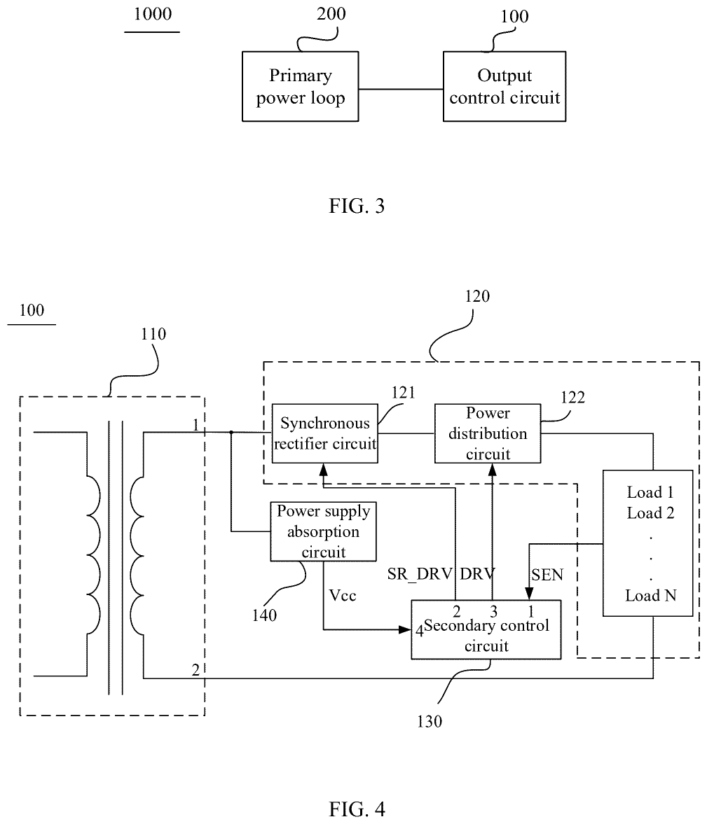

FIG. 3 is a schematic structural diagram of a switching power supply 1000 according to some embodiments of the present disclosure. As illustrated in FIG. 3, the switching power supply 1000 may include a primary power loop 200 and an output control circuit 100.

In a case where the switching power supply 1000 is a flyback converter, the circuitry in the switching power supply 1000 is generally named a loop. The loop design in the flyback converter achieves efficient, stable, and reliable energy conversion and control, such that the system performance meets expected requirements. Therefore, in the flyback converter, the “loop” is primarily intended to ensure the effective transfer and control of energy.

The primary power loop 200 is electrically connected to the output control circuit 100.

The primary power loop 200 may control energy storage and transfer for the power transformer 110 in the output control circuit 100, such that the output control circuit 100 may control a magnitude of the power required by at least one load.

FIG. 4 is a schematic structural diagram of an output control circuit in FIG. 3. As illustrated in FIG. 4, the output control circuit 100 may include a power transformer 110, a secondary power loop 120, a power supply absorption circuit 140, and a secondary control circuit 130.

One power transformer 110 is configured, and the secondary power loop 120 includes no inductor.

A first terminal of the secondary control circuit 130 is electrically connected to at least one load, a second terminal of the secondary control circuit 130 is electrically connected to a first control terminal of the secondary power loop 120, and a third terminal of the secondary control circuit 130 is electrically connected to the second control terminal of the secondary power loop 120.

A first terminal of the secondary power loop 120 is electrically connected to a first terminal of a secondary winding of the power transformer 110, a second terminal of the secondary power loop 120 is electrically connected to a second terminal of the secondary winding of the power transformer 110, and the at least one load is connected in series in the secondary power loop 120.

The secondary power loop 120 includes a synchronous rectifier circuit 121 and a power distribution circuit 122 that are connected in series. A first terminal of the synchronous rectifier circuit 121 is electrically connected to the first terminal of the secondary winding of the power transformer 110, a second terminal of the synchronous rectifier circuit 121 is electrically connected to an input terminal of the power distribution circuit 122, and an output terminal of the power distribution circuit 122 is electrically connected to the second terminal of the secondary winding of the power transformer 110 via the at least one load.

The expression “at least one load” means one load or a plurality of loads. In a case where the at least one load includes a plurality of loads, the plurality of loads are load 1, load 2, . . . , and load N.

The power transformer 110, the secondary power loop 120, and the secondary control circuit 130 may be separately configured, or may be integrally configured.

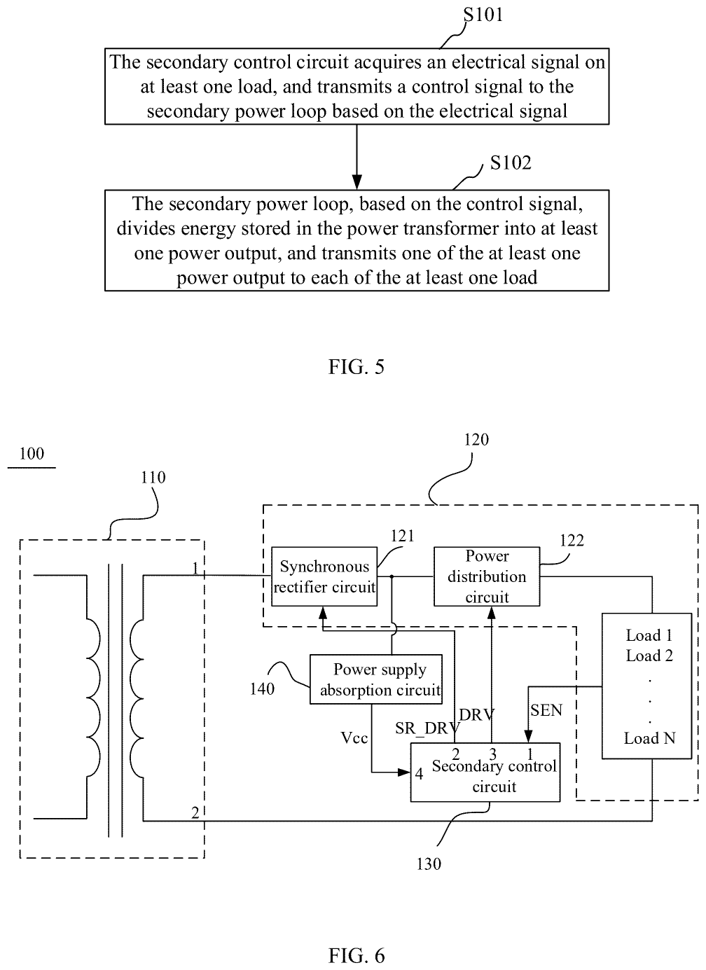

FIG. 5 is a schematic flowchart of an output control method according to some embodiments of the present disclosure. The method includes the following steps.

In S101, the secondary control circuit acquires an electrical signal on at least one load, and transmits a control signal to the secondary power loop based on the electrical signal.

The electrical signal SEN is used for representing energy required by the at least one load.

For example, in a case where the at least one load includes one load, the electrical signal SEN is used for representing energy required by the one load.

For example, in a case where the at least one load includes three loads, the electrical signal SEN is used for representing energy required by the three loads. The three loads are respectively load 1, load 2, and load 3; and correspondingly, the electrical signal SEN includes an electrical signal SEN1, an electrical signal SEN2, and an electrical signal SEN3. The electrical signal SEN1 is used for representing energy required by load 1, the electrical signal SEN2 is used for representing energy required by load 2, and the electrical signal SEN3 is used for representing energy required by load 3.

The electrical signal SEN may include a current signal ISEN and a voltage signal VSEN. The voltage signal VSEN may include a first voltage signal VSEN1, a second voltage signal VSEN2, and an n^{th} voltage signal VSENn.

The secondary control circuit may generate the control signal based on the electrical signal, and transmit the control signal to the secondary power loop.

In S102, the secondary power loop, based on the control signal, converts energy stored in the power transformer into at least one power output, and transmits one of the at least one power output to one of the at least one load.

For example, the secondary power loop transmits the first power output to a first load of the at least one load, such that an operating voltage of the first load is Vo1. The secondary power loop transmits the second power output to a second load of the at least one load, such that an operating voltage of the second load is Vo2. The secondary power loop transmits an n^{th} power output to an nth load of the at least one load, such that an operating voltage of the n^{th} load is Von.

The secondary control circuit 130 may acquire the electrical signal SEN from the at least one load. Since the electrical signal SEN represents the energy required by the load, the secondary control circuit 130 may transmit the control signal to the secondary power loop 120 based on the electrical signal SEN.

The load may be a constant-voltage load or a constant-current load, which is not limited in the embodiments of the present disclosure.

For example, in a case where the at least one load includes one load, the secondary power loop 120 converts the energy stored in the power transformer 110 into one power output. In a case where the at least one load includes a plurality of loads, such as three loads, the secondary power loop 120 divides the energy stored in the power transformer 110 into a plurality of power outputs corresponding to the number of loads, for example, three power outputs.

The secondary power loop 120 may, based on the control signal, convert energy stored in the power transformer 110 into one power output or divide the energy into at least two power outputs, and transmit one power output to each of the at least one load.

In a case where the at least one load includes a first load and a second load.

In a first case, with respect to each cycle where the power transformer 110 is in an energy release state, the secondary power loop 120 may divide the energy stored in the power transformer 110 into a first power output and a second power output based on the control signal. Furthermore, the secondary power loop 120 may transmit the first power output to the first load and the second power output to the second load, such that the first load and the second load may operate.

For example, in a first time period within the each cycle where the power transformer 110 is in an energy release state, the secondary power loop 120 may receive the energy released by the power transformer 110 in the first time period. Therefore, in the first time period, the secondary power loop 120 may convert a portion of the energy stored in the power transformer 110 into the first power output based on the control signal.

In a second time period within the each cycle where the power transformer 110 is in an energy release state, the secondary power loop 120 may receive the energy released by the power transformer 110 within the second time period. Therefore, in the second time period, the secondary power loop 120 may convert a remaining portion of the energy stored in the power transformer 110 into the second power output based on the control signal.

In a second case, with respect to two adjacent cycles where the power transformer 110 is in an energy release state, the secondary power loop 120 may receive the energy released by the power transformer 110 within a previous cycle. Therefore, the secondary power loop 120 may, based on the control signal, convert a portion of the energy stored in the power transformer 110 into the first power output within the previous cycle and transmit the first power output to the first load, such that the first load may operate.

The secondary power loop 120 may receive the energy released by the power transformer 110 within a subsequent cycle. Therefore, within the subsequent cycle, the secondary power loop 120 may convert a remaining portion of the energy stored in the power transformer 110 into the second power output and transmit the second power output to the second load, such that the second load may operate.

In addition, in a scenario where at least one load includes the first load and the second load, the secondary power loop 120 may adopt either the first case alone or the second case alone, or may adopt a combination of the first case and the second case, which is not limited in the embodiments of the present disclosure.

The combination of the first case and the second case means that: within each cycle of some cycles, the secondary power loop 120 divides the energy stored in the power transformer 110 into the first power output and the second power output. Within a previous cycle of two adjacent cycles of some other cycles, the secondary power loop 120 converts the energy stored in the power transformer 110 into the first power output; and within a subsequent cycle of the two adjacent cycles, the secondary power loop 120 converts the energy stored in the power transformer 110 into the second power output.

In a case where at least one load includes one load.

With respect to each cycle where the power transformer 110 is in an energy release state, the secondary power loop 120 may convert the energy stored in the power transformer 110 into one power output based on the control signal, and transmit the power output to the load, such that the load may operate.

In the output control circuit and control method as described above, the secondary control circuit acquires the electrical signal on the at least one load, and the secondary control circuit may transmit the control signal to the secondary power loop based on the electrical signal used for representing the energy required by the at least one load. In this way, the secondary power loop may convert the energy stored in the power transformer into one power output or divide the energy into at least two power outputs based on the control signal. Furthermore, the secondary power loop may transmit one power output to each of the at least one load, such that the at least one load may operate Since one power transformer is configured, and the secondary power loop includes no inductor, the numbers of power transformers and inductors in the output control circuit are reduced. In this way, the size of the output control circuit and the size of the switching power supply are reduced.

Based on the description of the above embodiments, exemplarily, one possible implementation of the output control circuit 100 is described hereinafter. FIG. 6 is a schematic structural diagram of an output control circuit in FIG. 3. As illustrated in FIG. 4 and FIG. 6, the output control circuit 100 may further include a power supply absorption circuit 140.

The output control circuit as illustrated in FIG. 6 is different from the output control circuit as illustrated in FIG. 4 in that the connection structures of the power supply absorption circuits 140 are different.

As illustrated in FIG. 4, an input terminal of the power supply absorption circuit 140 is electrically connected to the first terminal of the secondary winding of the power transformer 110, and an output terminal of the power supply absorption circuit 140 is electrically connected to a power terminal of the secondary control circuit 130.

As illustrated in FIG. 6, the input terminal of the power supply absorption circuit 140 is electrically connected to the third terminal of the secondary power loop 120, and the output terminal of the power supply absorption circuit 140 is electrically connected to the power terminal of the secondary control circuit 130.

The power supply absorption circuit 140 is configured to provide an operating voltage Vcc to the secondary control circuit 130 to start the secondary control circuit 130. In this way, the secondary control circuit 130 may control the secondary power loop 120.

In a case where the secondary power loop 120 converts the energy stored in the power transformer 110 into one power output or divides the energy into at least two power outputs, for example, the secondary power loop 120 switches from the first power output to the second power output of at least one power output, the secondary power loop 120 generates a spike voltage. The power supply absorption circuit 140 may absorb the spike voltage generated by the secondary power loop 120. This helps prevent the spike voltage from interfering with the secondary power loop 120.

In summary, the power supply absorption circuit may provide the operating voltage to the secondary control circuit start the secondary control circuit. Additionally, in a case where the secondary power loop converts the energy stored in the power transformer into one power output or two power outputs, the power supply absorption circuit may absorb the spike voltage generated by the secondary power loop, thereby preventing the spike voltage from interfering with the secondary power loop.

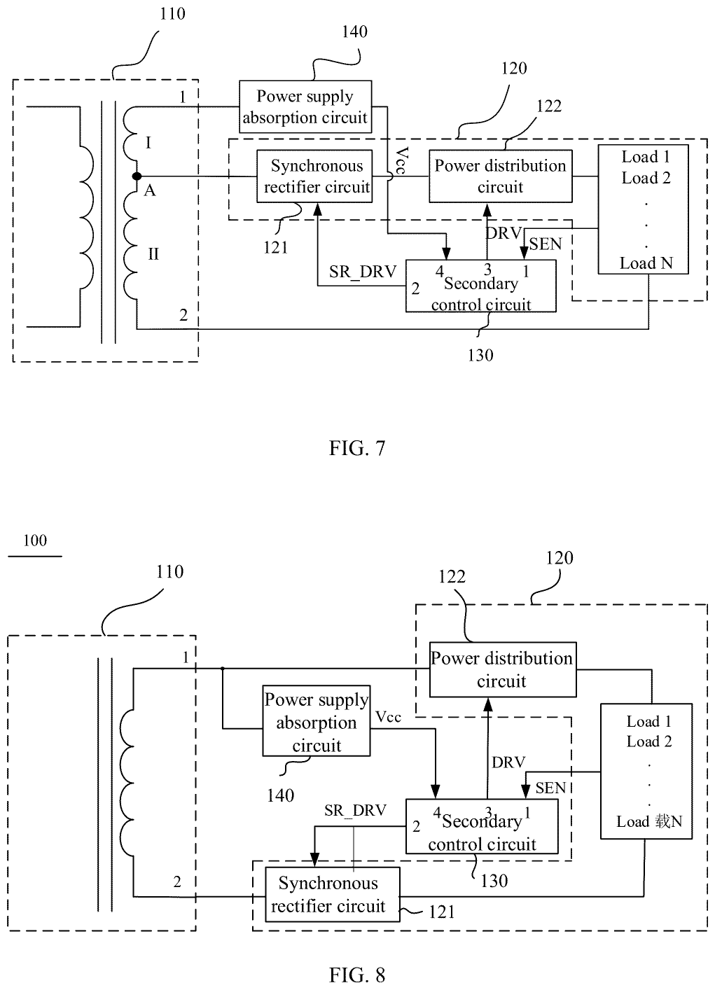

FIG. 7 is a schematic structural diagram of an output control circuit in FIG. 3.

As illustrated in FIG. 7, the first terminal of the secondary control circuit 130 is electrically connected to the at least one load, the second terminal of the secondary control circuit 130 is electrically connected to the first control terminal of the secondary power loop 120, and the third terminal of the secondary control circuit 130 is electrically connected to the second control terminal of the secondary power loop 120.

The input terminal of the power supply absorption circuit 140 and the first terminal of the secondary power loop 120 are both electrically connected to the first terminal of the secondary winding of the power transformer 110, the output terminal of the power supply absorption circuit 140 is electrically connected to the power terminal of the secondary control circuit 130, the second terminal of the secondary power loop 120 is electrically connected to the second terminal of the secondary winding of the power transformer 110, and the at least one load is connected in series in the secondary power loop 120.

The secondary power loop 120 includes a synchronous rectifier circuit 121 and a power distribution circuit 122 that are connected in series. A first terminal of the synchronous rectifier circuit 121 is electrically connected to the first terminal of the secondary winding of the power transformer 110, a second terminal of the synchronous rectifier circuit 121 is electrically connected to an input terminal of the power distribution circuit 122, and an output terminal of the power distribution circuit 122 is electrically connected to the second terminal of the secondary winding of the power transformer 110 via the at least one load.

As illustrated in FIG. 7, in a case where the operating voltage Vcc of the secondary control circuit 130 is equal to or greater than a predetermined voltage, the secondary winding of the power transformer 110 may include a central tap A.

The central tap A divides the coils of the seconding winding of the power transformer 110 into a first coil group I and a second coil group II. A first terminal of the first coil group I is electrically connected to the input terminal of the power supply absorption circuit 140, a second terminal of the first coil group I is electrically connected to a first terminal of the second coil group II, the central tap A is positioned between the second terminal of the first coil group I and the first terminal of the second coil group II, the central tap A is electrically connected to the first terminal of the secondary power loop 120, and a second terminal of the second coil group II is electrically connected to the second terminal of the secondary power loop 120.

By using the central tap A, the coils of the secondary winding of the power transformer 110 are divided into the first coil group I and the second coil group II. This allows the central tap A to change the number of turns in the coils of the secondary winding of the power transformer 110, thereby increasing the output voltage of the power transformer 110. In this way, the power supply absorption circuit 140 may provide a higher operating voltage Vcc to the secondary control circuit 130, thereby starting the secondary control circuit 130.

In summary, by utilizing the center tap, the number of turns in the coils of the secondary winding of the power transformer may be adjusted, such that the power supply absorption circuit may provide a higher operating voltage to the secondary control circuit.

Based on the description of the above embodiments, exemplarily, one possible implementation of the secondary power loop 120 is described hereinafter. As illustrated in FIG. 4, FIG. 6, and FIG. 7, the secondary power loop 120 may include a synchronous rectifier circuit 121 and a power distribution circuit 122.

A control terminal of the synchronous rectifier circuit 121 is electrically connected to the second terminal of the secondary control circuit 130, and a control terminal of the power distribution circuit 122 is electrically connected to the third terminal of the secondary control circuit 130.

The first terminal of the secondary winding of the power transformer 110 is electrically connected to a first terminal of the synchronous rectifier circuit 121, a second terminal of the synchronous rectifier circuit 121 is electrically connected to an input terminal of the power distribution circuit 122, and an output terminal of the power distribution circuit 122 is electrically connected to the second terminal of the secondary winding of the power transformer 110 via the at least one load.

FIG. 8 is a schematic structural diagram of an output control circuit in FIG. 3.

As illustrated in FIG. 8, the first terminal of the secondary control circuit 130 is electrically connected to the at least one load, the second terminal of the secondary control circuit 130 is electrically connected to the first control terminal of the secondary power loop 120, and the third terminal of the secondary control circuit 130 is electrically connected to the second control terminal of the secondary power loop 120.

The input terminal of the power supply absorption circuit 140 and the first terminal of the secondary power loop 120 are both electrically connected to the first terminal of the secondary winding of the power transformer 110, the output terminal of the power supply absorption circuit 140 is electrically connected to the power terminal of the secondary control circuit 130, and the second terminal of the secondary power loop 120 is electrically connected to the second terminal of the secondary winding of the power transformer 110.

As illustrated in FIG. 8, the secondary power loop 120 includes a synchronous rectifier circuit 122 and a power distribution circuit 122 that are connected in series. The first terminal of the secondary winding of the power transformer 110 is electrically connected to an input terminal of the power distribution circuit 122, an output terminal of the power distribution circuit 122 is electrically connected to a second terminal of the synchronous rectifier circuit 121 via the at least one load, and a first terminal of the synchronous rectifier circuit 121 is electrically connected to the second terminal of the secondary winding of the power transformer 110.

A control terminal of the synchronous rectifier circuit 121 is the first control terminal of the secondary power loop 120, and a control terminal of the power distribution circuit 122 is the second control terminal of the secondary power loop 120.

FIG. 4, FIG. 6, and FIG. 7 all illustrate that in a case where the first terminal of the secondary winding of the power transformer 110 is electrically connected to the first terminal of the synchronous rectifier circuit 121, the first terminal of the synchronous rectifier circuit 121 is the first terminal of the secondary power loop 120, and the output terminal of the power distribution circuit 122 is the second terminal of the secondary power loop 120. In this case, the synchronous rectifier circuit 121 is a high-side synchronous rectifier circuit.

FIG. 8 illustrates that in a case where the first terminal of the secondary winding of the power transformer 110 is electrically connected to the input terminal of the power distribution circuit 122, the input terminal of the power distribution circuit 122 is the first terminal of the secondary power loop 120, and the first terminal of the synchronous rectifier circuit 121 is the second terminal of the secondary power loop 120. In this case, the synchronous rectifier circuit 121 is a low-side synchronous rectifier circuit.

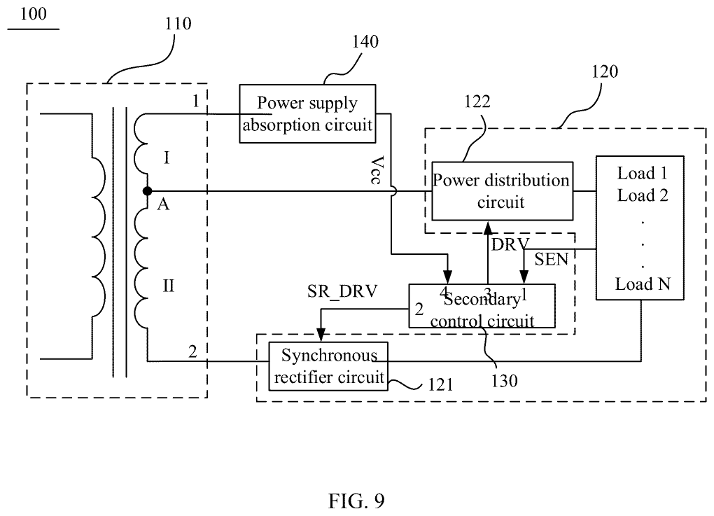

FIG. 9 is a schematic structural diagram of an output control circuit in FIG. 3. FIG. 9 illustrates a schematic structural diagram of the output control circuit 100 in a case where the secondary winding of the power transformer 110 includes a central tap A and the synchronous rectifier circuit 121 is a low-side synchronous rectifier circuit.

As illustrated in FIG. 9, the first terminal of the secondary control circuit 130 is electrically connected to the at least one load, the second terminal of the secondary control circuit 130 is electrically connected to the first control terminal of the secondary power loop 120, and the third terminal of the secondary control circuit 130 is electrically connected to the second control terminal of the secondary power loop 120.

The input terminal of the power supply absorption circuit 140 is electrically connected to the first terminal of the secondary winding of the power transformer 110, the output terminal of the power supply absorption circuit 140 is electrically connected to the power terminal of the secondary control circuit 130, and the second terminal of the secondary power loop 120 is electrically connected to the second terminal of the secondary winding of the power transformer 110.

The secondary power loop 120 includes a synchronous rectifier circuit 121 and a power distribution circuit 122 that are connected in series. The first terminal of the secondary winding of the power transformer 110 is electrically connected to an input terminal of the power distribution circuit 122, an output terminal of the power distribution circuit 122 is electrically connected to a second terminal of the synchronous rectifier circuit 121 via the at least one load, and a first terminal of the synchronous rectifier circuit 121 is electrically connected to the second terminal of the secondary winding of the power transformer 110.

The central tap A divides the coils of the seconding winding of the power transformer 110 into a first coil group I and a second coil group II. A first terminal of the first coil group I is electrically connected to the input terminal of the power supply absorption circuit 140, a second terminal of the first coil group I is electrically connected to a first terminal of the second coil group II, the central tap A is positioned between the second terminal of the first coil group I and the first terminal of the second coil group II, the central tap A is electrically connected to the first terminal of the secondary power loop 120, and a second terminal of the second coil group II is electrically connected to the second terminal of the secondary power loop 120.

FIG. 6 illustrates that in a case where the synchronous rectifier circuit 121 is a high-side synchronous rectifier circuit and the secondary winding of the power transformer 110 includes no central A, the input terminal of the power supply absorption circuit 140 is electrically connected to the third terminal of the secondary power loop 120. Herein, a connection point between the second terminal of the synchronous rectifier circuit 121 and the input terminal of the power distribution circuit 122 serves as the third terminal of the secondary power loop 120.

In some examples, the synchronous rectifier circuit 121 may be a synchronous rectifier with zero voltage switching (ZVS) functionality, a diode, or a transistor, which is not limited in the embodiments of the present disclosure. For ease of understanding, the embodiments hereinafter are described by an example where the synchronous rectifier circuit 121 is a transistor.

The control signal output by the secondary control circuit 130 may include a first control signal SR_DRV and a second control signal DRV.

Using a scenario where the synchronous rectifier circuit 121 in FIG. 6 is a transistor as an example, the transistor is turned on based on the first control signal SR_DRV, such that a primary winding of the power transformer 110 transfers the stored energy to the secondary winding of the power transformer 110. In this way, the synchronous rectifier circuit 121 may rectify the stored energy in the power transformer 110, such that the rectified energy is acquired. Furthermore, the synchronous rectifier circuit 121 may transmit the rectified energy to the power distribution circuit 122.

Hence, the power distribution circuit 122 may turn on the distribution assembly in the power distribution circuit 122 based on the second control signal DRV, such that the turned-on distribution assembly may store the rectified energy. In this way, the power distribution circuit 122 converts the rectified energy into one power output based on the turned-on distribution assembly. Hence, the power distribution circuit 122 may convert the rectified energy into one power output or divide the energy into at least two power outputs based on the second control signal DRV. Moreover, the power distribution circuit 122 may transmit at least one power output to the at least one load, such that the at least one load may operate.

In FIG. 4 and FIG. 6 to FIG. 9, the first terminal of the secondary winding of the power transformer 110 is denoted as 1, the second terminal of the secondary winding of the power transformer 110 is denoted as 2, the first terminal of the secondary control circuit 130 is denoted as 1, the second terminal of the secondary control circuit 130 is denoted as 2, the third terminal of the secondary control circuit 130 is denoted as 3, and the power terminal of the secondary control circuit 130 is denoted as 4.

In summary, the synchronous rectifier circuit may, based on the first control signal, rectifier the energy stored in the power transformer, and transmit the rectified energy to the power distribution circuit, such that the power distribution circuit may acquire the rectified energy. Hence, the power distribution circuit may, based on the second control signal, convert the rectified energy into one power output or at least two power outputs, and transmit at least one power output to the at least one load, such that the at least one load may operate.

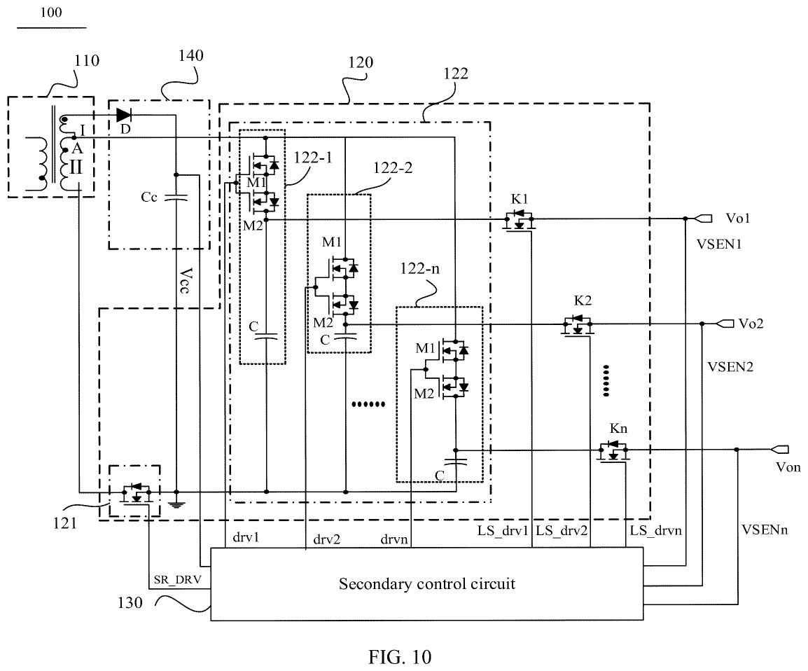

Based on the description of the above embodiments, exemplarily, one possible implementation of the power distribution circuit 122 is described hereinafter. FIG. 10 is a schematic structural diagram of the secondary power loop 120 in FIG. 9.

As illustrated in FIG. 10, the first terminal of the secondary control circuit 130 is electrically connected to the at least one load, the second terminal of the secondary control circuit 130 is electrically connected to the first control terminal of the secondary power loop 120, and the third terminal of the secondary control circuit 130 is electrically connected to the second control terminal of the secondary power loop 120.

The input terminal of the power supply absorption circuit 140 is electrically connected to the first terminal of the secondary winding of the power transformer 110, the output terminal of the power supply absorption circuit 140 is electrically connected to the power terminal of the secondary control circuit 130, and the second terminal of the secondary power loop 120 is electrically connected to the second terminal of the secondary winding of the power transformer 110.

The secondary power loop 120 includes a synchronous rectifier circuit 121 and a power distribution circuit 122 that are connected in series. The first terminal of the secondary winding of the power transformer 110 is electrically connected to an input terminal of the power distribution circuit 122, an output terminal of the power distribution circuit 122 is electrically connected to a second terminal of the synchronous rectifier circuit 121 via the at least one load, and a first terminal of the synchronous rectifier circuit 121 is electrically connected to the second terminal of the secondary winding of the power transformer 110.

The central tap A divides the coils of the seconding winding of the power transformer 110 into a first coil group I and a second coil group II. A first terminal of the first coil group I is electrically connected to the input terminal of the power supply absorption circuit 140, a second terminal of the first coil group I is electrically connected to a first terminal of the second coil group II, the central tap A is positioned between the second terminal of the first coil group I and the first terminal of the second coil group II, the central tap A is electrically connected to the first terminal of the secondary power loop 120, and a second terminal of the second coil group II is electrically connected to the second terminal of the secondary power loop 120.

As illustrated in FIG. 10, the power distribution circuit 122 may include at least two distribution assemblies and at least two switching transistors.

The distribution assemblies are in one-to-one correspondence with the switching transistors.

The at least two distribution assemblies may include a first distribution assembly 122-1, a second distribution assembly 122-2, and an n^{th} distribution assembly 122-n. The at least two switching transistors may include a first switching transistor K1, a second switching transistor K2, and an nth switching transistor Kn, wherein n is an integer greater than or equal to 1.

A control terminal of the distribution assembly and a control terminal of the switching transistor are both electrically connected to the third terminal of the secondary control circuit 130, a first terminal of the distribution assembly is electrically connected to the second terminal of the synchronous rectifier circuit 121 or the first terminal of the secondary winding of the power transformer 110, a second terminal of the distribution assembly is electrically connected to a first terminal of the switching transistor, and a second terminal of the switching transistor is electrically connected to the at least one load.

The control terminal of the distribution assembly and the control terminal of the switching transistor are both the second control terminal of the secondary power loop 120.

As illustrated in FIG. 4, FIG. 6, and FIG. 7, the control terminal of the distribution assembly and the control terminal of the switching transistor are both electrically connected to the third terminal of the secondary control circuit 130, the first terminal of the distribution assembly is electrically connected to the second terminal of the synchronous rectifier circuit 121, the second terminal of the distribution assembly is electrically connected to the first terminal of the switching transistor, and the second terminal of the switching transistor is electrically connected to the at least one load.

As illustrated in FIG. 8 to FIG. 11, the control terminal of the distribution assembly and the control terminal of the switching transistor are both electrically connected to the third terminal of the secondary control circuit 130, the first terminal of the distribution assembly is electrically connected to the first terminal of the secondary winding of the power transformer 110, the second terminal of the distribution assembly is electrically connected to the first terminal of the switching transistor, and the second terminal of the switching transistor is electrically connected to the at least one load.

In addition, the secondary power loop 120 in FIG. 4 and the secondary power loops 120 in FIG. 6 to FIG. 9 have the same internal structure. Therefore, description is given using the structure of the secondary power loop 120 in FIG. 10 as an example.

The second control signal DRV may include at least one first sub-control signal drvn and at least one second sub-control signal LS_drvn, where n is an integer greater than or equal to 1.

The at least two distribution assemblies may be turned on based on the first sub-control signal drv, such that the rectified energy is stored in the at least two distribution assemblies. The at least two distribution assemblies stay in a turned-on state for a specific time period, such that the rectified energy stored in the at least two distribution assemblies is output as one power output. In this way, the at least two distribution assemblies may convert the rectified energy into one power output or divide the rectified energy into at least two power outputs.

For example, the first distribution assembly 122-1 is turned on based on a first sub-control signal drv1. The second distribution assembly 122-2 is turned on based on another first sub-control signal drv2. The n^{th} distribution assembly 122-n is turned on based on another first sub-control signal drvn.

Furthermore, the switching transistors may be turned on under the effect of the second sub-control signal LS_drv, such that the switching transistors enable electrical connection between the at least two distribution assemblies and the at least one load.

For example, the first switching transistor K1 is turned on under the effect of a second sub-control signal LS_drv1. The second switching transistor K2 is turned on under the effect of another second sub-control signal LS_drv2. The n^{th} switching transistor Kn is turned on under the effect of another second sub-control signal LS_drvn.

In a case where the switching transistors enable electrical connection between the at least two distribution assemblies and the at least one load, the at least two distribution assemblies may transfer at least one power output to the at least one load via the turned-on switching transistors.

Hence, in a case where the switching transistors enable electrical connection between the at least two distribution assemblies and the at least one load, the at least two distribution assemblies may transfer at least one power output to the at least one load.

Therefore, the at least two distribution assemblies are configured to be turned on based on the first sub-control signal, such that the rectified energy is converted into one power output or divided into at least two power outputs. In this way, the switching transistor may be turned on based on the second sub-control signal, such that the at least two distribution assemblies are eclectically connected to the at least one load. Hence, the at least two distribution assemblies may transmit at least one power output to the at least one load.

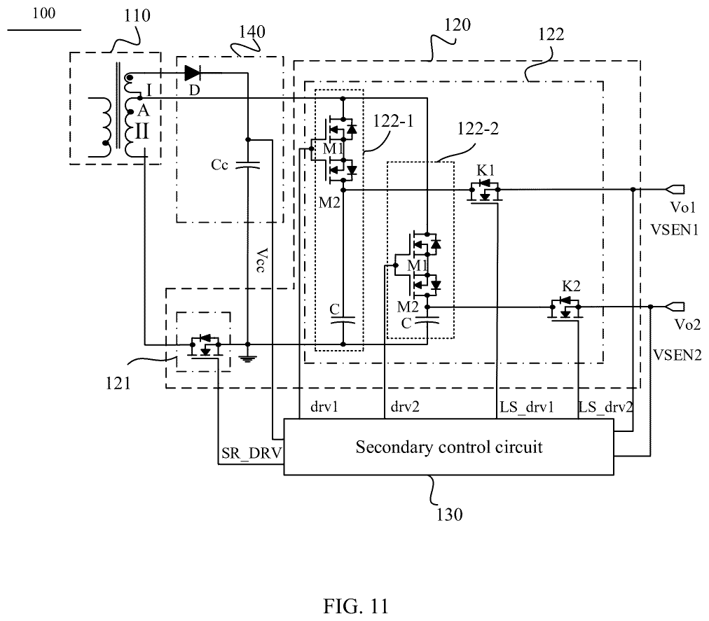

Based on the description of the above embodiments, exemplarily, one possible implementation of the power distribution circuit 122 is described hereinafter. FIG. 11 is a schematic structural diagram of the power distribution circuit 122 in FIG. 10.

As illustrated in FIG. 11, the first terminal of the secondary control circuit 130 is electrically connected to the at least one load, the second terminal of the secondary control circuit 130 is electrically connected to the first control terminal of the secondary power loop 120, and the third terminal of the secondary control circuit 130 is electrically connected to the second control terminal of the secondary power loop 120.

The input terminal of the power supply absorption circuit 140 is electrically connected to the first terminal of the secondary winding of the power transformer 110, the output terminal of the power supply absorption circuit 140 is electrically connected to the power terminal of the secondary control circuit 130, and the second terminal of the secondary power loop 120 is electrically connected to the second terminal of the secondary winding of the power transformer 110.

The secondary power loop 120 includes a synchronous rectifier circuit 121 and a power distribution circuit 122 that are connected in series. The first terminal of the secondary winding of the power transformer 110 is electrically connected to an input terminal of the power distribution circuit 122, an output terminal of the power distribution circuit 122 is electrically connected to a second terminal of the synchronous rectifier circuit 121 via the at least one load, and a first terminal of the synchronous rectifier circuit 121 is electrically connected to the second terminal of the secondary winding of the power transformer 110. The at least one load includes a first load and a second load.

The central tap A divides the coils of the seconding winding of the power transformer 110 into a first coil group I and a second coil group II. A first terminal of the first coil group I is electrically connected to the input terminal of the power supply absorption circuit 140, a second terminal of the first coil group I is electrically connected to a first terminal of the second coil group II, the central tap A is positioned between the second terminal of the first coil group I and the first terminal of the second coil group II, the central tap A is electrically connected to the first terminal of the secondary power loop 120, and a second terminal of the second coil group II is electrically connected to the second terminal of the secondary power loop 120.

As illustrated in FIG. 11, the at least two distribution assemblies include a first distribution assembly 122-1 and a second distribution assembly 122-2, and the at least two switching transistors include a first switching transistor K1 and a second switching transistor K2.

A control terminal of the first distribution assembly 122-1, a control terminal of the second distribution assembly 122-2, a first terminal of the first switching transistor K1 and a control terminal of the second switching transistor K2 are all electrically connected to the third terminal of the secondary control circuit 130, a first terminal of the first distribution assembly 122-1 and a first terminal of the second distribution assembly 122-2 are both electrically connected to the second terminal of the synchronous rectifier circuit 121 or the first terminal of the secondary winding of the power transformer 110, a second terminal of the first distribution assembly 122-1 is electrically connected to the first terminal of the first switching transistor K1, and a second terminal of the second distribution assembly 122-2 is electrically connected to a first terminal of the second switching transistor K2.

On the basis of the above description, the operating principles of the power distribution circuit 122 in a case where the at least one load includes a first load and a second load and in a case where the at least one load includes one load are respectively described.

In a case where the at least one load includes a first load and a second load.

With respect to each cycle where the power transformer 110 is in an energy release state, the first distribution assembly 122-1 may be turned on in a first time period within the each cycle based on a first sub-control signal drv1, such that a portion of the rectified energy is stored in the first distribution assembly 122-1. Hence, the first distribution assembly 122-1 may acquire the first power output.

In this way, the first switching transistor K1 may be turned on in the first time period within the each cycle under the effect of a second sub-control signal LS_drv1, such that the first distribution assembly 122-1 is electrically connected to the first load. Hence, the first distribution assembly 122-1 may transmit the first power output to the first load.

The second distribution assembly 122-2 may be turned on in a second time period within the each cycle based on another first sub-control signal drv2, such that another portion of the rectified energy is stored in the second distribution assembly 122-2. In this way, the second distribution assembly 122-2 may acquire the second power output.

In this way, the second switching transistor K2 may be turned on within the second time period within the each cycle under the effect of another second sub-control signal LS_drv2, such that the second distribution assembly 122-2 is electrically connected to the second load. Hence, the first distribution assembly 122-2 may transmit the second power output to the second load.

In this way, the power distribution circuit 122 may transmit the first power output to the first load and transmit the second power output to the second load, such that the secondary power loop 120 may transmit the first power output to the first load and transmit the second power output to the second load.

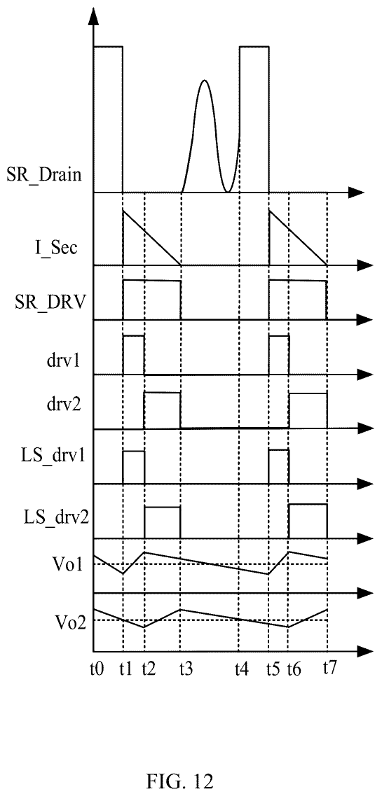

FIG. 12 illustrates a schematic diagram of an operating waveform of the output control circuit in FIG. 11. With respect to each cycle where the power transformer 110 is in an energy release state, the operating principles of the output control circuit 100 and the power distribution circuit 122 are described in detail in a case where the at least one load includes a first load and a second load. t1-t3 represents a first cycle where the power transformer 110 is in an energy release state, t1-t2 represents a first time period within the first cycle, t2-t3 represents a second time period within the first cycle, t5-t7 represents a second cycle where the power transformer 110 is in an energy release state, t5-t6 represents a first time period within the second cycle, and t6-t7 represents a second time period within the second cycle.

In time period t0-t1, the first terminal of the synchronous rectifier circuit 121 is at a high level. In this case, the control switching transistor in the primary power loop 200 is turned on, such that the power transformer 110 is in an energy storage state.

In time period t1-t3, current I_Sec of the synchronous rectifier circuit 121 decreases to zero from the peak. In this case, the synchronous rectifier circuit 121 rectifies the energy stored in the power transformer 110 under the effect of the first control signal SR_DRV. Furthermore, the synchronous rectifier circuit 121 may transmit the rectified energy to the power distribution circuit 122, such that the power distribution circuit 122 may transmit the first power output to the first load such that the operating voltage of the first load is Vo1, and transmit the second power output to the second load such that the operating voltage of the second load is Vo2.

In time period t1-t2, the first control signal drv1 is at a high level, such that the first distribution assembly 122-1 is turned on. Hence, the first distribution assembly 122-1 may acquire the first power output. In this time period, the second sub-control signal LS_drv1 is at a high level, such that the first distribution assembly 122-1 is electrically connected to the first load. Hence, the first distribution assembly 122-1 may transmit the first power output to the first load.

In time period t2-t3, the first control signal drv2 is at a high level, such that the second distribution assembly 122-2 is turned on. In this way, the second distribution assembly 122-2 may acquire the second power output. In this time period, the second sub-control signal LS_drv2 is at a high level, such that the second distribution assembly 122-2 is electrically connected to the second load. Hence, the first distribution assembly 122-2 may transmit the second power output to the second load.

In time period t4-t5, the control switching transistor in the primary power loop 200 is turned on, such that the power transformer 110 is in an energy storage state.

In time period t5-t7, the operating principle of the power distribution circuit 122 is similar to the operating principle of the power distribution circuit 122 in time period t1-t3, which is not described herein any further.

With respect to two adjacent cycles (including a previous cycle and a subsequent cycle) where the power transformer 110 is in an energy release state, the first distribution assembly 122-1 may be turned on within the previous cycle under the effect of the first sub-control signal drv1, such that the rectified energy is stored in the first distribution assembly 122-1. Hence, the first distribution assembly 122-1 may acquire the first power output.

In this way, the first switching transistor K1 may be turned on within the previous cycle under the effect of the second sub-control signal LS_drv1, such that the first distribution assembly 122-1 is electrically connected to the first load. Hence, the first distribution assembly 122-1 may transmit the first power output to the first load.

The second distribution assembly 122-2 may be turned on within the subsequent cycle based on the first sub-control signal drv2, such that the rectified energy is stored in the second distribution assembly 122-2. In this way, the second distribution assembly 122-2 may acquire the second power output.

In this way, the second switching transistor K2 may be turned on within the subsequent cycle under the effect of the second sub-control signal LS_drv2, such that the second distribution assembly 122-2 is electrically connected to the second load. Hence, the first distribution assembly 122-2 may transmit the second power output to the second load.

In this way, within the previous cycle, the first distribution assembly 122-1 may transmit the first power output to the first load. Furthermore, within the subsequent cycle, the second distribution assembly 122-2 may transmit the second power output to the second load.

In addition, the first distribution assembly 122-1 may be turned on within the previous cycle, or may be turned on within the subsequent cycle. Correspondingly, the second distribution assembly 122-2 may be turned on within the subsequent cycle, or may be turned on within the previous cycle. That is, the turn-on sequence of the first distribution assembly 122-1 and the second distribution assembly 122-2 is not limited in the embodiments of the present disclosure.

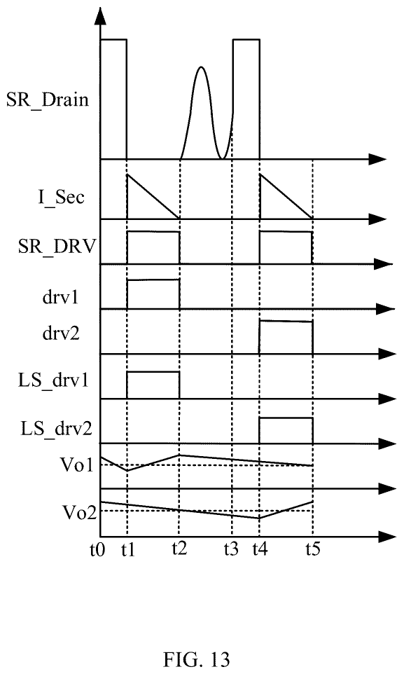

FIG. 13 illustrates a schematic diagram of an operating waveform of the output control circuit in FIG. 11. With respect to two adjacent cycles where the power transformer 110 is in an energy release state, the operating principles of the output control circuit 100 and the power distribution circuit 122 are described in detail in a case where the at least one load includes a first load and a second load. t1-t2 represents a previous cycle where the power transformer 110 is in an energy release state, and t4-t5 represents a subsequent cycle where the power transformer 110 is in an energy release state.

In time period t0-t1, the first terminal of the synchronous rectifier circuit 121 is at a high level. In this case, the control switching transistor in the primary power loop 200 is turned on, such that the power transformer 110 is in an energy storage state.

In time period t1-t2, a current I_Sec of the synchronous rectifier circuit 121 decreases to zero from the peak. In this case, the synchronous rectifier circuit 121 rectifies the energy stored in the power transformer 110 under the effect of the first control signal SR_DRV, and transmits the rectified energy to the power distribution assembly 122. In this time period, the first control signal drv1 is at a high level, such that the first distribution assembly 122-1 is turned on. Hence, the first distribution assembly 122-1 may acquire the first power output. Furthermore, the second sub-control signal LS_drv1 is at a high level, such that the first distribution assembly 122-1 is electrically connected to the first load. Hence, the first distribution assembly 122-1 may transmit the first power output to the first load, such that the operating voltage of the first load is Vo1.

In time period t3-t4, the first terminal of the synchronous rectifier circuit 121 is at a high level. In this case, the control switching transistor in the primary power loop 200 is turned on, such that the power transformer 110 is in an energy storage state.

In time period t4-t5, a current I_Sec of the synchronous rectifier circuit 121 decreases to zero from the peak. In this case, the synchronous rectifier circuit 121 rectifies the energy stored in the power transformer 110 under the effect of the first control signal SR_DRV, and transmits the rectified energy to the power distribution assembly 122. In this time period, the first control signal drv2 is at a high level, such that the second distribution assembly 122-2 is turned on. In this way, the second distribution assembly 122-1 may acquire the second power output. Furthermore, the second sub-control signal LS_drv2 is at a high level, such that the second distribution assembly 122-1 is electrically connected to the second load. Hence, the second distribution assembly 122-1 may transmit the second power output to the second load, such that the operating voltage of the second load is Vo2.

In a case where the at least one load includes one load.

With respect to each cycle where the power transformer 110 is in an energy release state, the first distribution assembly 122-1 may be turned on within the each cycle under the effect of the first sub-control signal drv1, such that a portion of the rectified energy is stored in the first distribution assembly 122-1. Hence, the first distribution assembly 122-1 may acquire a portion of the first power output.

The second distribution assembly 122-2 may be turned on within the each cycle under the effect of the first sub-control signal drv2, such that another portion of the rectified energy is stored in the second distribution assembly 122-2. Hence, the first distribution assembly 122-2 may acquire another portion of the first power output.

Furthermore, the first switching transistor K1 may be turned on within the each cycle under the effect of the second sub-control signal LS_drv1, such that the first distribution assembly 122-1 and the second distribution assembly 122-2 are both electrically connected to the one load. Hence, the first distribution assembly 122-1 and the second distribution assembly 122-2 may transmit one power output to the one load.

Alternatively, the second switching transistor K2 may be turned on within the each cycle under the effect of the second sub-control signal LS_drv2, such that the first distribution assembly 122-1 and the second distribution assembly 122-2 are both electrically connected to the one load. Hence, the first distribution assembly 122-1 and the second distribution assembly 122-2 may transmit one power output to the one load.

In this way, within the each cycle, the power distribution circuit 122 may transmit one power output to the one load, such that the secondary power loop 120 may transmit one power output to the one load.

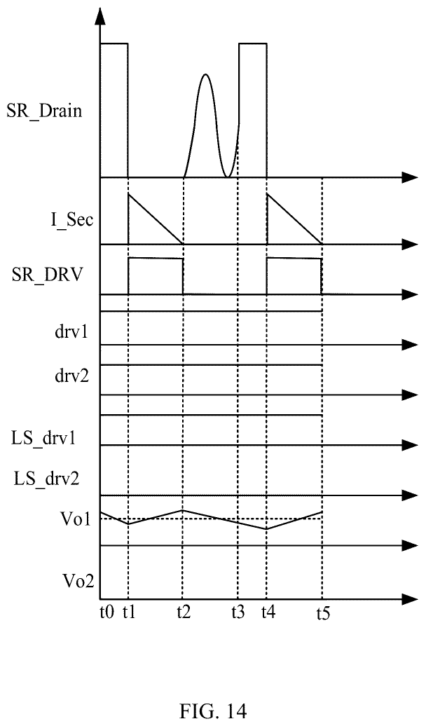

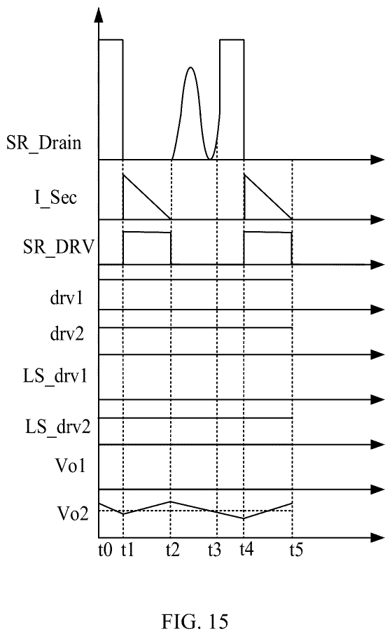

FIG. 14 and FIG. 15 both illustrate a schematic diagram of an operating waveform of the output control circuit in FIG. 11. With respect to each cycle where the power transformer 110 is in an energy release state, the operating principles of the output control circuit 100 and the power distribution circuit 122 are described in detail in a case where the at least one load includes one load. t1-t2 represents a first cycle where the power transformer 110 is in an energy release state, and t4-t5 represents a second cycle where the power transformer 110 is in an energy release state.

As illustrated in FIG. 14, in time period t0-t1, the first terminal of the synchronous rectifier circuit 121 is at a high level. In this case, the control switching transistor in the primary power loop 200 is turned on, such that the power transformer 110 is in an energy storage state.

In time period t1-t2, a current I_Sec of the synchronous rectifier circuit 121 decreases to zero from the peak. In this case, the synchronous rectifier circuit 121 rectifies the energy stored in the power transformer 110 under the effect of the first control signal SR_DRV, and transmits the rectified energy to the power distribution assembly 122. In this time period, the first control signal drv1 is at a high level, such that the first distribution assembly 122-1 is turned on. Hence, the first distribution assembly 122-1 may acquire a portion of the first power output. Meanwhile, the first control signal drv2 is at a high level, such that the second distribution assembly 122-2 is turned on. Hence, the first distribution assembly 122-1 may acquire another portion of the first power output.

In this way, the first distribution assembly 122-1 and the second distribution assembly 122-1 jointly receive one power output. Furthermore, in this time period, the second sub-control signal LS_drv1 is at a high level, such that the first switching transistor K1 is turned on. Further, both the first distribution assembly 122-1 and the second distribution assembly 122-2 are both electrically connected to one load. Hence, the first distribution assembly 122-1 and the second distribution assembly 122-2 may transmit one power output to the one load, such that the operating voltage of the one load is Vo1.

In time period t3-t4, the operating principle of the synchronous rectifier circuit 121 is similar to the operating principle of the synchronous rectifier circuit 121 in time period t0-t1, which is not described herein any further.

In time period t4-t5, the operating principle of the power distribution circuit 122 is similar to the operating principle of the power distribution circuit 122 in time period t1-t2, which is not described herein any further.

As illustrated in FIG. 15, in time period t0-t1, the first terminal of the synchronous rectifier circuit 121 is at a high level. In this case, the control switching transistor in the primary power loop 200 is turned on, such that the power transformer 110 is in an energy storage state.

In time period t1-t2, current I_Sec of the synchronous rectifier circuit 121 decreases to zero from the peak. In this case, the synchronous rectifier circuit 121 rectifies the energy stored in the power transformer 110 under the effect of the first control signal SR_DRV, and transmits the rectified energy to the power distribution assembly 122. In this time period, the first control signal drv1 is at a high level, such that the first distribution assembly 122-1 is turned on. Hence, the first distribution assembly 122-1 may acquire a portion of the first power output. Meanwhile, the first control signal drv2 is at a high level, such that the second distribution assembly 122-2 is turned on. Hence, the first distribution assembly 122-1 may acquire another portion of the first power output. In this way, the first distribution assembly 122-1 and the second distribution assembly 122-1 jointly receive one power output.

Furthermore, in this time period, the second sub-control signal LS_drv2 is at a high level, such that the second switching transistor K2 is turned on. Further, both the first distribution assembly 122-1 and the second distribution assembly 122-2 are both electrically connected to one load. Hence, the first distribution assembly 122-1 and the second distribution assembly 122-2 may transmit one power output to the one load, such that the operating voltage of the one load is Vo2.

In time period t3-t4, the operating principle of the synchronous rectifier circuit 121 is similar to the operating principle of the synchronous rectifier circuit 121 in time period t0-t1, which is not described herein any further.

In time period t4-t5, the operating principle of the power distribution circuit 122 is similar to the operating principle of the power distribution circuit 122 in time period t1-t2, which is not described herein any further.

Based on the description of the above embodiments, exemplarily, one possible implementation of the distribution assembly is described hereinafter. As illustrated in FIG. 10 and FIG. 11, each of the distribution assemblies may include a first power transistor M1 and an output capacitor C.

A control terminal of the first power transistor M1 is electrically connected to the second terminal of the secondary control circuit 130, a first terminal of the first power transistor M1 is electrically connected to the second terminal of the synchronous rectifier circuit 121 or the first terminal of the secondary winding of the power transformer 110, a second terminal of the first power transistor M1 is electrically connected to a first terminal of the output capacitor C, a second terminal of the output capacitor C is grounded, the first terminal of the first switching transistor K1 or the first terminal of the second switching transistor K2 is electrically connected between the second terminal of the first power transistor M1 and the first terminal of the output capacitor C.

The operating principle of the first distribution assembly 122-1 is the same as the operating principle of the second distribution assembly 122-2. Description is given in the embodiments hereinafter using a first distribution assembly 122-1 in a case where the at least one load includes one load as an example.

In a case where the first sub-control signal drv1 is at a high level, the first power transistor M1 is turned on, such that the output capacitor stores a portion of the rectified energy. Hence, the first distribution assembly 122-1 may acquire a portion of the first power output.

In some examples, a capacitance value of the output capacitor C is less than a predetermined capacitance value.

Furthermore, in a case where at least one load includes one load, since the first distribution assembly 122-1 and the second distribution assembly 122-2 are connected in parallel, the output capacitor C in the first distribution assembly 122-1 and the output capacitor C in the second distribution assembly 122-2 are also connected in parallel. Therefore, the output capacitor C is a low-capacity capacitor, which may substantially reduce the size of the output control circuit 100.

In summary, by controlling the first power transistor to be turned on or turned off, the output capacitor may store the rectified energy. Hence, the distribution assemblies may convert the rectified energy into one power output, or divide the rectified energy into at least two power outputs.

Based on the description of the above embodiments, exemplarily, one possible implementation of the distribution assembly is described hereinafter. As illustrated in FIG. 10 and FIG. 11, the distribution assembly may further include a second power transistor M2.

A control terminal of the second power transistor M2 is electrically connected to the second terminal of the secondary control circuit 130, a second terminal of the second power transistor M2 is electrically connected to the first terminal of the first power transistor M1, and a first terminal of the second power transistor M2 is electrically connected to the first terminal of the output capacitor C.

In a case where first sub-control signal drv1 is at a high level, the first power transistor M1 is turned on, and the rectified energy may flow from a positive terminal to a negative terminal. In this case, the second power transistor M2 is turned off. In this way, the rectified energy may be prevented from flowing from the negative terminal to the positive terminal, which achieves the effect of preventing backflow.

In addition, in a case where the power distribution circuit 122 converts the energy stored in the power transformer 110 into power output or divides the energy stored in the power transformer 110 into at least two power outputs, for example, the power distribution circuit 122 switches from the power output to the second power output, the power transistors in the at least two distribution assemblies may not be turned on simultaneously. Instead, a dead time is required.

Besides, the power transistor as illustrated in FIGS. 10 and 11 may be a metal-oxide-semiconductor field-effect transistor (MOSFET) device. Meanwhile, the transistor may also be an insulated-gate bipolar transistor (IGBT) device, an integrated gate-commutated thyristor (IGCT) device, a gate turn-off thyristor (GTO) device, a silicon-controlled rectifier (SCR) device, a junction gate field-effect transistor (JFET) device, a MOS-controlled thyristor (MCT) device, a GaN-based power device, a SiC-based power device, or the like. The embodiment of the present disclosure sets no limitation thereto.

Therefore, the second power transistor enables the distribution assembly to have anti-backflow functionality.

Based on the description of the above embodiments, exemplarily, one possible implementation of the power supply absorption circuit 140 is described hereinafter. As illustrated in FIG. 10 and FIG. 11, the power supply absorption circuit 140 may include a diode D and a first capacitor Cc.

A first terminal of the diode D is electrically connected to the first terminal of the secondary windings of the power transformer 110, a second terminal of the diode D is electrically connected to a first terminal of the first capacitor Cc, a second terminal of the first capacitor Cc is grounded, and the power terminal of the secondary control circuit 130 is electrically connected between the second terminal of the diode D and the first terminal of the first capacitor Cc.

In a case where the input terminal of the power supply absorption circuit 140 is electrically connected to the third terminal of the secondary power loop 120, the first terminal of the diode D is electrically connected to the third terminal of the secondary power loop 120.

In a case where the secondary control circuit 130 is in a startup phase, a current path is formed between the secondary winding of the power transformer 110, the diode D, the first capacitor Cc, and the body diode of the synchronous rectifier circuit 121, such that the voltage across the first capacitor Cc is gradually built up. Further, the voltage Vcc across the first capacitor Cc may be built up. As a result, the power supply absorption circuit 140 may provide the operating voltage Vcc to the secondary control circuit 130, such that the secondary control circuit 130 may control the secondary power loop 120.

In a case where the secondary power loop 120 converts the energy stored in the power transformer 110 into one power output or divides the energy into two power outputs, the first capacitor Cc may absorb the spike voltage generated by the secondary power loop 120, thereby preventing the spike voltage from interfering with the secondary power loop 120.

In summary, by using the diode and the first capacitor, the power supply absorption circuit may provide the operating voltage to the secondary control circuit, and absorb the spike voltage generated by the secondary power loop.

It should be finally noted that the above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. An output control circuit, comprising: a power transformer, a secondary power loop, and a secondary control circuit, wherein one power transformer is configured, and the secondary power loop does not comprise an inductor; wherein
a first terminal of the secondary control circuit is electrically connected to at least one load, a second terminal of the secondary control circuit is electrically connected to a first control terminal of the secondary power loop, and a third terminal of the secondary control circuit is electrically connected to a second control terminal of the secondary power loop;
a first terminal of the secondary power loop is electrically connected to a first terminal of a secondary winding of the power transformer, a second terminal of the secondary power loop is electrically connected to a second terminal of the secondary winding of the power transformer, and the at least one load is connected in series in the secondary power loop;
the secondary control circuit is configured to acquire an electrical signal on the at least one load, and transmit a control signal to the secondary power loop based on the electrical signal, wherein the electrical signal is used for representing energy required by the at least one load; and
the secondary power loop is configured to, based on the control signal, convert energy stored in the power transformer into at least one power output, and transmit one of the at least one power output to each of the at least one load.

2. The output control circuit according to claim 1, wherein
in a case where the at least one load comprises a first load and a second load, with respect to each cycle where the power transformer is in an energy release state, the secondary power loop is configured to, based on the control signal, divide the energy stored in the power transformer into a first power output and a second power output, transmit the first power output to the first load, and transmit the second power output to the second load; or, with respect to two adjacent cycles where the power transformer is in an energy release state, the secondary power loop is configured to, based on the control signal, convert the energy stored in the power transformer into a first power output and transmit the first power output to the first load within a previous cycle of the two adjacent cycles, and convert the energy stored in the power transformer into a second power output and transmit the second power output to the second load within a subsequent cycle of the two adjacent cycles; or
in a case where the at least one load comprises one load, with respect to each cycle where the power transformer is in an energy release state, the secondary power loop is configured to, based on the control signal, convert the energy stored in the power transformer into one power output and transmit the one power output to the one load.

3. The output control circuit according to claim 2, further comprising: a power supply absorption circuit; wherein
an input terminal of the power supply absorption circuit is electrically connected to the first terminal of the secondary winding of the power transformer or a third terminal of the secondary power loop, and an output terminal of the power supply absorption circuit is electrically connected to a power terminal of the secondary control circuit; and
the power supply absorption circuit is configured to provide an operating voltage to the secondary control circuit to start the secondary control circuit.

4. The output control circuit according to claim 3, wherein the power supply absorption circuit is further configured to absorb a spike voltage generated by the secondary power loop in a case where the secondary power loop converts the energy stored in the power transformer into at least one power output.

5. The output control circuit according to claim 3, wherein the power supply absorption circuit comprises a diode and a first capacitor;
wherein a first terminal of the diode is electrically connected to the first terminal of the secondary windings of the power transformer or the third terminal of the secondary power loop, a second terminal of the diode is electrically connected to a first terminal of the first capacitor, a second terminal of the first capacitor is grounded, and the power terminal of the secondary control circuit is electrically connected between the second terminal of the diode and the first terminal of the first capacitor.

6. The output control circuit according to claim 3, wherein in a case where the operating voltage of the secondary control circuit is equal to or greater than a predetermined voltage, the secondary winding of the power transformer comprises a central tap;
wherein the central tap is configured to divide coils of the seconding winding of the power transformer into a first coil group and a second coil group, wherein a first terminal of the first coil group is electrically connected to the input terminal of the power supply absorption circuit, a second terminal of the first coil group is electrically connected to a first terminal of the second coil group, the central tap is positioned between the second terminal of the first coil group and the first terminal of the second coil group, the central tap is electrically connected to the first terminal of the secondary power loop, and a second terminal of the second coil group is electrically connected to the second terminal of the secondary power loop.

7. The output control circuit according to claim 1, wherein the control signal comprises a first control signal and a second control signal; and the secondary power loop comprises a synchronous rectifier circuit and a power distribution circuit; wherein
a control terminal of the synchronous rectifier circuit is electrically connected to the second terminal of the secondary control circuit, and a control terminal of the power distribution circuit is electrically connected to the third terminal of the secondary control circuit;
the first terminal of the secondary winding of the power transformer is electrically connected to a first terminal of the synchronous rectifier circuit, a second terminal of the synchronous rectifier circuit is electrically connected to an input terminal of the power distribution circuit, and an output terminal of the power distribution circuit is electrically connected to the second terminal of the secondary winding of the power transformer via the at least one load; or the first terminal of the secondary winding of the power transformer is electrically connected to an input terminal of the power distribution circuit, an output terminal of the power distribution circuit is electrically connected to a second terminal of the synchronous rectifier circuit via the at least one load, and a first terminal of the synchronous rectifier circuit is electrically connected to the second terminal of the secondary winding of the power transformer;
the synchronous rectifier circuit is configured to, based on the first control signal, rectify the energy stored in the power transformer, and transmit rectified energy to the power distribution circuit; and
the power distribution circuit is configured to, based on the second control signal, convert the rectified energy into at least one power output, and transmit the at least one power output to the at least one load.

8. The output control circuit according to claim 7, wherein the second control signal comprises at least one first sub-control signal and at least one second sub-control signal; and the power distribution circuit comprises at least two distribution assemblies and at least two switching transistors, the distribution assemblies being in one-to-one correspondence with the switching transistors; wherein
a control terminal of each of the distribution assemblies and a control terminal of each of the switching transistors are both electrically connected to the third terminal of the secondary control circuit, a first terminal of the each of the distribution assemblies is electrically connected to the second terminal of the synchronous rectifier circuit or the first terminal of the secondary winding of the power transformer, a second terminal of the each of the distribution assemblies is electrically connected to a first terminal of the each of the switching transistors, and a second terminal of the each of switching transistors is electrically connected to the at least one load;
the at least two distribution assemblies are configured to be turned on based on the at least one first sub-control signal to convert the rectified energy into at least one power output respectively; and
the at least two switching transistors are configured to enable electrical connection between the at least two distribution assemblies and the at least one load based on the at least one second sub-control signal to transmit the at least one power output to the at least one load respectively.

9. The output control circuit according to claim 8, wherein the at least two distribution assemblies comprise a first distribution assembly and a second distribution assembly, the at least two switching transistors comprise a first switching transistor and a second switching transistor, the at least one first sub-control signal comprises a first sub-control signal and another first sub-control signal, and the at least one second sub-control signal comprises a second sub-control signal and another second sub-control signal; wherein
a control terminal of the first distribution assembly, a control terminal of the second distribution assembly, a first terminal of the first switching transistor and a control terminal of the second switching transistor are all electrically connected to the third terminal of the secondary control circuit, a first terminal of the first distribution assembly and a first terminal of the second distribution assembly are both electrically connected to the second terminal of the synchronous rectifier circuit or the first terminal of the secondary winding of the power transformer, a second terminal of the first distribution assembly is electrically connected to the first terminal of the first switching transistor, and a second terminal of the second distribution assembly is electrically connected to a first terminal of the second switching transistor;
in a case where the at least one load comprises a first load and a second load, with respect to each cycle where the power transformer is in an energy release state, the first distribution assembly is configured to be turned on in a first time period within the each cycle based on the first sub-control signal, to acquire the first power output;
the first switching transistor is configured to enable electrical connection between the first distribution assembly and the first load in the first time period within the each cycle based on the second sub-control signal, to transmit the first power output to the first load;
the second distribution assembly is configured to be turned on in a second time period within the each cycle based on the another first sub-control signal, to acquire the second power output; and
the second switching transistor is configured to enable electrical connection between the second distribution assembly and the second load in a second time period within the each cycle based on the another second sub-control signal, to transmit the second power output to the second load; or
with respect to two adjacent cycles where the power transformer is in an energy release state, the first distribution assembly is configured to be turned on within a previous cycle of the two adjacent cycles based on the first sub-control signal, to acquire the first power output;
the first switching transistor is configured to enable electrical connection between the first distribution assembly and the first load within the previous cycle of the two adjacent cycles based on the second sub-control signal, to transmit the first power output to the first load;
the second distribution assembly is configured to be turned on within a subsequent cycle of the two adjacent cycles based on the another first sub-control signal, to acquire the second power output; and
the second switching transistor is configured to enable electrical connection between the second distribution assembly and the second load within the subsequent cycle of the two adjacent cycles based on the another second sub-control signal, to transmit the second power output to the second load; or
in a case where the at least one load comprises one load, with respect to each cycle where the power transformer is in an energy release state, the first distribution assembly is configured to be turned on within the each cycle based on the first sub-control signal, to acquire a portion of power in the one power output;
the second distribution assembly is configured to be turned on within the each cycle based on the another first sub-control signal, to acquire another portion of power in the one power output; and
the first switching transistor is configured to be turned on within the each cycle based on the second sub-control signal, and enable electrical connection between the first distribution assembly and the one load, to transmit the one power output to the one load; or the second switching transistor is configured to be turned on within the each cycle based on the another second sub-control signal, and enable electrical connection between the second distribution assembly and the one load, to transmit the one power output to the one load.

10. The output control circuit according to claim 9, wherein each of the distribution assemblies comprises a first power transistor and an output capacitor;
wherein a control terminal of the first power transistor is electrically connected to the second terminal of the secondary control circuit, a first terminal of the first power transistor is electrically connected to the second terminal of the synchronous rectifier circuit or the first terminal of the secondary winding of the power transformer, a second terminal of the first power transistor is electrically connected to a first terminal of the output capacitor, a second terminal of the output capacitor is grounded, the first terminal of the first switching transistor or the first terminal of the second switching transistor is electrically connected between the second terminal of the first power transistor and the first terminal of the output capacitor.

11. The output control circuit according to claim 10, wherein the distribution assembly further comprises a second power transistor;
wherein a control terminal of the second power transistor is electrically connected to the second terminal of the secondary control circuit, a second terminal of the second power transistor is electrically connected to the first terminal of the first power transistor, and a first terminal of the second power transistor is electrically connected to the first terminal of the output capacitor.

12. A switching power supply, comprising a primary power loop and an output control circuit, wherein the primary power loop is electrically connected to the output control circuit;
the primary power loop is configured to control energy storage and transfer for a power transformer in the output control circuit, such that the output control circuit control a magnitude of a power required by at least one load; and
the output control circuit comprises: a power transformer, a secondary power loop, and a secondary control circuit, wherein one power transformer is configured, and the secondary power loop does not comprise an inductor; wherein
a first terminal of the secondary control circuit is electrically connected to the at least one load, a second terminal of the secondary control circuit is electrically connected to a first control terminal of the secondary power loop, and a third terminal of the secondary control circuit is electrically connected to a second control terminal of the secondary power loop;
a first terminal of the secondary power loop is electrically connected to a first terminal of a secondary winding of the power transformer, a second terminal of the secondary power loop is electrically connected to a second terminal of the secondary winding of the power transformer, and the at least one load is connected in series in the secondary power loop;
the secondary control circuit is configured to acquire an electrical signal on the at least one load, and transmit a control signal to the secondary power loop based on the electrical signal, wherein the electrical signal is used for representing energy required by the at least one load; and
the secondary power loop is configured to, based on the control signal, convert energy stored in the power transformer into at least one power output, and transmit one of the at least one power output to each of the at least one load.

13. The switching power supply according to claim 12, wherein
in a case where the at least one load comprises a first load and a second load, with respect to each cycle where the power transformer is in an energy release state, the secondary power loop is configured to, based on the control signal, divide the energy stored in the power transformer into a first power output and a second power output, transmit the first power output to the first load, and transmit the second power output to the second load; or, with respect to two adjacent cycles where the power transformer is in an energy release state, the secondary power loop is configured to, based on the control signal, convert the energy stored in the power transformer into a first power output and transmit the first power output to the first load within a previous cycle of the two adjacent cycles, and convert the energy stored in the power transformer into a second power output and transmit the second power output to the second load within a subsequent cycle of the two adjacent cycles; or
in a case where the at least one load comprises one load, with respect to each cycle where the power transformer is in an energy release state, the secondary power loop is configured to, based on the control signal, convert the energy stored in the power transformer into one power output and transmit the one power output to the one load.

14. The switching power supply according to claim 13, wherein the output control circuit further comprises: a power supply absorption circuit; wherein
an input terminal of the power supply absorption circuit is electrically connected to the first terminal of the secondary winding of the power transformer or a third terminal of the secondary power loop, and an output terminal of the power supply absorption circuit is electrically connected to a power terminal of the secondary control circuit; and
the power supply absorption circuit is configured to provide an operating voltage to the secondary control circuit to start the secondary control circuit.

15. The switching power supply according to claim 14, wherein the power supply absorption circuit is further configured to absorb a spike voltage generated by the secondary power loop in a case where the secondary power loop converts the energy stored in the power transformer into at least one power output.

16. The switching power supply according to claim 14, wherein the power supply absorption circuit comprises a diode and a first capacitor;
wherein a first terminal of the diode is electrically connected to the first terminal of the secondary windings of the power transformer or the third terminal of the secondary power loop, a second terminal of the diode is electrically connected to a first terminal of the first capacitor, a second terminal of the first capacitor is grounded, and the power terminal of the secondary control circuit is electrically connected between the second terminal of the diode and the first terminal of the first capacitor.

17. The switching power supply according to claim 14, wherein in a case where the operating voltage of the secondary control circuit is equal to or greater than a predetermined voltage, the secondary winding of the power transformer comprises a central tap;
wherein the central tap is configured to divide coils of the seconding winding of the power transformer into a first coil group and a second coil group, wherein a first terminal of the first coil group is electrically connected to the input terminal of the power supply absorption circuit, a second terminal of the first coil group is electrically connected to a first terminal of the second coil group, the central tap is positioned between the second terminal of the first coil group and the first terminal of the second coil group, the central tap is electrically connected to the first terminal of the secondary power loop, and a second terminal of the second coil group is electrically connected to the second terminal of the secondary power loop.

18. The switching power supply according to claim 12, wherein the control signal comprises a first control signal and a second control signal; and the secondary power loop comprises a synchronous rectifier circuit and a power distribution circuit; wherein
a control terminal of the synchronous rectifier circuit is electrically connected to the second terminal of the secondary control circuit, and a control terminal of the power distribution circuit is electrically connected to the third terminal of the secondary control circuit;
the first terminal of the secondary winding of the power transformer is electrically connected to a first terminal of the synchronous rectifier circuit, a second terminal of the synchronous rectifier circuit is electrically connected to an input terminal of the power distribution circuit, and an output terminal of the power distribution circuit is electrically connected to the second terminal of the secondary winding of the power transformer via the at least one load; or the first terminal of the secondary winding of the power transformer is electrically connected to an input terminal of the power distribution circuit, an output terminal of the power distribution circuit is electrically connected to a second terminal of the synchronous rectifier circuit via the at least one load, and a first terminal of the synchronous rectifier circuit is electrically connected to the second terminal of the secondary winding of the power transformer;
the synchronous rectifier circuit is configured to, based on the first control signal, rectify the energy stored in the power transformer, and transmit rectified energy to the power distribution circuit; and
the power distribution circuit is configured to, based on the second control signal, convert the rectified energy into at least one power output, and transmit the at least one power output to the at least one load.

19. The switching power supply according to claim 18, wherein the second control signal comprises at least one first sub-control signal and at least one second sub-control signal; and the power distribution circuit comprises at least two distribution assemblies and at least two switching transistors, the distribution assemblies being in one-to-one correspondence with the switching transistors; wherein
a control terminal of each of the distribution assemblies and a control terminal of each of the switching transistors are both electrically connected to the third terminal of the secondary control circuit, a first terminal of the each of the distribution assemblies is electrically connected to the second terminal of the synchronous rectifier circuit or the first terminal of the secondary winding of the power transformer, a second terminal of the each of the distribution assemblies is electrically connected to a first terminal of the each of the switching transistors, and a second terminal of the each of switching transistors is electrically connected to the at least one load;
the at least two distribution assemblies are configured to be turned on based on the at least one first sub-control signal to convert the rectified energy into at least one power output respectively; and
the at least two switching transistors are configured to enable electrical connection between the at least two distribution assemblies and the at least one load based on the at least one second sub-control signal to transmit the at least one power output to the at least one load respectively.

20. The switching power supply according to claim 19, wherein the at least two distribution assemblies comprise a first distribution assembly and a second distribution assembly, the at least two switching transistors comprise a first switching transistor and a second switching transistor, the at least one first sub-control signal comprises a first sub-control signal and another first sub-control signal, and the at least one second sub-control signal comprises a second sub-control signal and another second sub-control signal; wherein
a control terminal of the first distribution assembly, a control terminal of the second distribution assembly, a first terminal of the first switching transistor and a control terminal of the second switching transistor are all electrically connected to the third terminal of the secondary control circuit, a first terminal of the first distribution assembly and a first terminal of the second distribution assembly are both electrically connected to the second terminal of the synchronous rectifier circuit or the first terminal of the secondary winding of the power transformer, a second terminal of the first distribution assembly is electrically connected to the first terminal of the first switching transistor, and a second terminal of the second distribution assembly is electrically connected to a first terminal of the second switching transistor;
in a case where the at least one load comprises a first load and a second load, with respect to each cycle where the power transformer is in an energy release state, the first distribution assembly is configured to be turned on in a first time period within the each cycle based on the first sub-control signal, to acquire the first power output;
the first switching transistor is configured to enable electrical connection between the first distribution assembly and the first load in the first time period within the each cycle based on the second sub-control signal, to transmit the first power output to the first load;
the second distribution assembly is configured to be turned on in a second time period within the each cycle based on the another first sub-control signal, to acquire the second power output; and
the second switching transistor is configured to enable electrical connection between the second distribution assembly and the second load in a second time period within the each cycle based on the another second sub-control signal, to transmit the second power output to the second load; or
with respect to two adjacent cycles where the power transformer is in an energy release state, the first distribution assembly is configured to be turned on within a previous cycle of the two adjacent cycles based on the first sub-control signal, to acquire the first power output;
the first switching transistor is configured to enable electrical connection between the first distribution assembly and the first load within the previous cycle of the two adjacent cycles based on the second sub-control signal, to transmit the first power output to the first load;
the second distribution assembly is configured to be turned on within a subsequent cycle of the two adjacent cycles based on the another first sub-control signal, to acquire the second power output; and
the second switching transistor is configured to enable electrical connection between the second distribution assembly and the second load within the subsequent cycle of the two adjacent cycles based on the another second sub-control signal, to transmit the second power output to the second load; or
in a case where the at least one load comprises one load, with respect to each cycle where the power transformer is in an energy release state, the first distribution assembly is configured to be turned on within the each cycle based on the first sub-control signal, to acquire a portion of power in the one power output;
the second distribution assembly is configured to be turned on within the each cycle based on the another first sub-control signal, to acquire another portion of power in the one power output; and
the first switching transistor is configured to be turned on within the each cycle based on the second sub-control signal, and enable electrical connection between the first distribution assembly and the one load, to transmit the one power output to the one load; or the second switching transistor is configured to be turned on within the each cycle based on the another second sub-control signal, and enable electrical connection between the second distribution assembly and the one load, to transmit the one power output to the one load.
